(19) United States
(12) Patent Application Publication
(10) Pub. No.: US 2022/0061364 A1
(43) Pub. Date: Mar. 3, 2022

(54) ONION FOOD PRODUCT AND METHOD OF MAKING AND USE THEREOF

(71) Applicant: Olam West Coast, Inc., Fresno, CA (US)

(72) Inventors: Neil MULLER, Fresno, CA (US); James HASTINGS, Fresno, CA (US)

(21) Appl. No.: 17/458,666

(22) Filed: Aug. 27, 2021

Related U.S. Application Data
(60) Provisional application No. 63/070,854, filed on Aug. 27, 2020.

(51) Int. Cl. A23L 5/00; A23B 7/10; A23L 19/00

(52) U.S. Cl. CPC A23L 5/55; A23V 2002/00; A23L 19/03; A23B 7/10

(57) ABSTRACT

Onions in an aqueous brine have one or more acids chosen from lactic acid, citric acid, and phosphoric acid; and at least one acid chosen from ascorbic acid and bisulfite, which makes it possible for an onion food product to achieve commercial sterility. Although makeable in other ways, an onion product results from onions in the aqueous brine being sealed in a container, and optionally inverted, and heated.

### CROSS-REFERENCE TO RELATED APPLICATIONS

The present application claims priority benefit of U.S. Provisional Application No. 63/070,854, filed 27 Aug. 2020, which application is hereby incorporated herein by reference in its entirety.

### FIELD

The present description concerns onions in an aqueous brine having one or more acids chosen from lactic acid, citric acid, and phosphoric acid; and at least one acid chosen from ascorbic acid and bisulfite. Although makeable in other ways, the onions in the aqueous brine are sealable in a container, and inverted and heated.

### INTRODUCTION

Rehydrating or hydrating onions involves concerns regarding uniform hydration, onion browning upon heating, onion flavor, onion separation and clumping, and storage shelf life of the packaged onions. For example, pickling alters onions flavor.

Objects and advantages of the embodiments will be set forth in part in the description which follows, and in part will be obvious from the description, or may be learned by practice of the description. Objects and advantages of the description will be realized and attained by means of the elements and combinations particularly pointed out in the appended claims.

It is to be understood that both the foregoing general description and the following detailed description are exemplary and explanatory only and are not restrictive of any invention, as claimed.

The accompanying drawings, which are incorporated in and constitute a part of this specification, illustrate embodiments and together with the description, serve to explain the principles.

### BRIEF DESCRIPTION OF THE DRAWINGS

FIG. 1A is an embodiment of a container. FIG. 1B is an embodiment of a container from FIG. 1A but inverted.

### EMBODIMENTS

Reference will now be made in detail to embodiments, examples of which are illustrated in the accompanying drawings. Wherever possible, the same reference numbers will be used throughout the drawings to refer to the same or like parts.

An onion food product comprises onions in an aqueous brine which comprises at least one acid chosen from lactic acid, citric acid, and phosphoric acid; and at least one acid chosen from ascorbic acid and bisulfite, and water, and the aqueous brine has a pH ranging from 1.5 to 4.5.

In some embodiments, the onions have a form chosen from chopped, diced, minced, and sliced onions. In some embodiments, the onions have a form chosen from whole and peeled onions.

In some embodiments, the onions are made from dehydrated, fresh, or frozen onions.

In some embodiments, the onion food product further comprises at least one vegetable other than onions or at least one spice, but the onion is the major vegetable ingredient by weight of any vegetables and spices.

In particular, the onions have a weight percentage amount Wt % relative to total weight of the onions and any other optional vegetables and spices. The term, Wt % (drained onions), refers to the weight percent of the drained onions (if needed) relative to any other optional drained vegetables and spices including the onions.

$$Wt \% ( onions ) = wt ( onions ) X 100 \% \qquad wt ( ingredients )$$

For example, onions, other optional vegetables, and optional spices are drained (if wet) and the drained (if wet) onions, other optional vegetables, and optional spices are weighed. The results are, e.g., as follows:

| | | |
|---|---|---|
| Wt (onions) | 99.00 g | Wt % (onions) = 99.00% |
| Wt (peppers) | 0.99 g | Wt % (peppers) = 0.99% |
| Wt (parsley) | 0.01 g | Wt % (parsley) = 0.01% |
| Wt (ingredients) | 100.00 g | Wt % (ingredients) = 100% |

In some embodiments, the onions are present in an amount Wt %(onions) above 50%, 60%, 70%, 80%, 90%, 95%, 98%, 99%, 99.9% or 100%. In some embodiments the onions are present in an amount Wt %(onions) ranging from 55% to 98%, from 60% to 95%, or from 70% to 85%.

In some embodiments, the onion food product further comprises at least one spice, but the onion is the major vegetable ingredient by weight of any optional vegetables and spices. In some embodiments, the at least one spice is chosen from parsley, basil, oregano, sage, tarragon, and thyme. In some embodiments, the at least one spice is present in an amount Wt %(spice) less than 0.1% or 0.01% or 0.001% by weight of any optional vegetables and spices.

In some embodiments, the onion food product further comprises at least one vegetable different than onion, but the onion is the major vegetable ingredient by weight of any optional vegetables and spices. In some embodiments, the other vegetables are chosen from broccoli, mushrooms, squash, zucchini, garlic, and peppers. In some embodiments, the at least one vegetable different than onion is present in an amount Wt %(other vegetables) greater than 0% but less than 3%, 5%, 7.5%, 15%, 20%, 25%, 30%, 35%, 40%, or 45% by weight of any vegetables and spices.

As noted herein, the onions are in an aqueous brine, which comprises water and at least one acid chosen from lactic acid, citric acid, and phosphoric acid; and at least one acid chosen from ascorbic acid and bisulfite.

In some embodiments, the aqueous brine is present in an amount above 15%, 20%, 30%, 40%, or 50% wt % by weight relative to the weight of the onions and aqueous brine.

In some embodiments, the aqueous brine has a liquid part consisting of water. In some embodiments of the aqueous brine, the liquid part comprises water and at least one other liquid. In some embodiments of the aqueous brine, the water is present in an amount greater than 50% v/v relative to the total volume of the water plus the volume of the at least one other liquid. In some embodiments, the amount is greater than 60% v/v or 70% v/v or 96% v/v or 99% v/v. In some embodiments, the amount ranges from 75% to 95% v/v or from 80% to 90% v/v.

Water is obtainable from many sources. The water is potable and suitable for human consumption. In some embodiments, the water is taken from public sources, filtered and/or sterilized.

In some embodiments, the at least one other liquid is an organic liquid suitable for human consumption. In some embodiments, the organic liquid is an edible oil, such as an edible oil of plant, animal or synthetic origin. In some embodiments, the edible oil is chosen from olive oil, soybean oil, sunflower oil, and rapeseed oil.

In some embodiments, the aqueous brine further comprises sodium chloride in an amount ranging from 3 to 20 w/w % by weight of the sodium chloride relative to the water and sodium chloride. In some embodiments, the weight is ranges from 6 to 18 w/w % by weight of the sodium relative to the water and sodium chloride.

In some embodiments, the aqueous brine further comprises one or more other brine salts chosen from sodium sulfate, potassium chloride, and calcium chloride. In some embodiments, the one or more other brine salts are present in an amount ranging from 0.1 to 10 w/w % or 0.5 to 4 w/w % by weight of the sodium chloride.

In some embodiments, in the aqueous brine, the lactic acid is present in an amount ranging from 0.1 to 8.0 wt/wt %; the citric acid is present in an amount ranging from 0.01 to 5.0 wt/wt %; and the ascorbic acid is present in an amount ranging from 0.01 to 5.0 wt/wt %, in which wt/wt % refers to the weight relative to the total weight of the lactic acid, citric acid, and ascorbic acid.

Bisulfite is in a form for consumption. For example, the form of bisulfite is sodium bisulfite.

In some embodiments, in the aqueous brine, the lactic acid is present in an amount ranging from 0.1 to 8.0 wt/wt %; the citric acid is present in an amount ranging from 0.01 to 5.0 wt/wt %; and sodium bisulfite is present in an amount ranging from 0.01 to 1.25 wt/wt %, in which wt/wt % refers to the weight relative to the total weight of the lactic acid, citric acid, and sodium bisulfite. The relative amount of bisulfite could be determined for other bisulfites by reference to the amount of sodium bisulfite.

In some embodiments, in the aqueous brine, the lactic acid is present in an amount ranging from 0.1 to 8.0 wt/wt %; the citric acid is present in an amount ranging from 0.01 to 5.0 wt/wt %; and phosphoric acid is present in an amount ranging from 0.01 to 1.25 wt/wt %, in which wt/wt % refers to the weight relative to the total weight of the lactic acid, citric acid, and phosphoric acid. The relative amount of phosphoric acid could be determined for various forms (dicalcium phosphate, hexametaphosphate, sodium phosphate, and tricalcium phosphate) by reference to the amount of sodium bisulfite.

In some embodiments, in the aqueous brine, the lactic acid is present in an amount ranging from 0.1 to 8.0 wt/wt %; the citric acid is present in an amount ranging from 0.01 to 5.0 wt/wt %; the ascorbic acid is present in an amount ranging from 0.01 to 5.0 wt/wt %, and sodium bisulfite is present in an amount ranging from 0.01 to 1.25 wt/wt %, in which wt/wt % refers to the weight relative to the total weight of the lactic acid, citric acid, ascorbic acid, and sodium bisulfite. The relative amount of bisulfite could be determined for other bisulfites by reference to the amount of sodium bisulfite.

In some embodiments, in the aqueous brine, the lactic acid is present in an amount ranging from 0.1 to 8.0 wt/wt %; the citric acid is present in an amount ranging from 0.01 to 5.0 wt/wt %; the ascorbic acid is present in an amount ranging from 0.01 to 5.0 wt/wt %, and phosphoric acid is present in an amount ranging from 0.01 to 1.25 wt/wt %, in which wt/wt % refers to the weight relative to the total weight of the lactic acid, citric acid, ascorbic acid, and phosphoric acid. The relative amount of bisulfite could be determined for other bisulfites by reference to the amount of sodium bisulfite.

In some embodiments, in the aqueous brine, the lactic acid is present in an amount ranging from 0.1 to 8.0 wt/wt %; the citric acid is present in an amount ranging from 0.01 to 5.0 wt/wt %; the phosphoric acid is present in an amount ranging from 0.01 to 5.0 wt/wt %, and bisulfite is present in an amount ranging from 0.01 to 1.25 wt/wt %, in which wt/wt % refers to the weight relative to the total weight of the lactic acid, citric acid, ascorbic acid, and phosphoric acid. The relative amount of bisulfite could be determined for other bisulfites by reference to the amount of sodium bisulfite.

In some embodiments, the aqueous brine has a pH ranging from 1.5 to 3.5 or from 1.5 to 4.5.

An onion product comprises a container comprising a compartment containing the onion food product described herein.

A method of nourishing comprises eating the onion food product described herein. In some embodiments, the onion food product is consumed by a human for nourishment.

A method of making an onion food product comprises containing, in a first compartment of a first container, onions and an aqueous brine comprising lactic acid, citric acid, ascorbic acid, and water, and wherein the aqueous brine has a pH ranging from 1.5 to 4.5.

The onion food product is makeable by mixing, in any relative order, onions; any at least one optional vegetable other than onion; any at least one optional spice; water; any at least one optional liquid; any optional brine salts; one or more acids chosen from lactic acid, citric acid, and phosphoric acid; and at least one acid chosen from ascorbic acid and bisulfite.

In some embodiments, the mixing occurs in a first compartment of a first container. In some embodiments, the first compartment of the first container is sealed.

In some embodiments, the method further comprises, containing, in the first compartment of the first container, onions and an aqueous brine comprising one or more acids chosen from lactic acid, citric acid, and phosphoric acid; and at least one acid chosen from ascorbic acid and bisulfite, and water; the aqueous brine has a pH ranging from 1.5 to 4.5 or another pH described herein; and the aqueous brine has a temperature maintained above 165° F. for at least 15 minutes. The temperature and period of time are sufficient to sterilize the inside of the first compartment of the first container and its contents. In some embodiments, the temperature is above 175° F., 180° F., 188° F. or 198° F., or the temperature ranges from 188 to 211° F. In some embodiments, the period of time ranges from 15 minutes to 360 minutes or from 45 minutes to 200 minutes.

In some embodiments, the method further comprises inverting the first compartment of the first container while maintaining the aqueous brine at a temperature above 165° F. for at least 15 minutes (or other described temperature or time).

The two or three or four or five acids—one or more acids chosen from lactic acid, citric acid, and phosphoric acid; and at least one acid chosen from ascorbic acid and bisulfite—make the resultant onion food product to be smoother in flavor. If only one of the two or three or four or five acids were used, the acidic bite would make the resultant onion food product's flavor is less desirable. The two or three or four or five acids—one or more acids chosen from lactic acid, citric acid, and phosphoric acid; and at least one acid chosen from ascorbic acid and bisulfite—makes it possible for the resultant onion food product to slow browning, which tends to occur after about one month when, e.g., ascorbic acid is absent from the three acids.

In some embodiments, aqueous brine is made from mixing the two or three or four or five acids—one or more acids chosen from lactic acid, citric acid, and phosphoric acid; and at least one acid chosen from ascorbic acid and bisulfite—and water. In some embodiments, the two or three or four or five acids—one or more acids chosen from lactic acid, citric acid, and phosphoric acid; and at least one acid chosen from ascorbic acid and bisulfite—are mixed as aqueous solutions from storage vessels (totes, drums, or bulk containers) containing the aqueous acid a given strength (5%, 10%, 15%, 20%, 25%, 30%, 35%, 40%, 45%, 50%, etc.). In some embodiments, the aqueous brine is made from mixing the conjugate base of one or more of the three to five acids and water. In some embodiments, sodium bisulfite is mixed with water. In some embodiments, dicalcium phosphate, hexametaphosphate, sodium phosphate, or tricalcium phosphate is mixed with water.

In some embodiments, the method further comprises containing, in the first compartment of the first container, onions and water. In some embodiments, the water is already in the form of the aqueous brine. In some embodiment, the method further comprises adding at least one optional other brine salts to the water to make a precursor to the aqueous brine. In some embodiments, the method further comprises thereafter adding, to the water and onions; one or more acids chosen from lactic acid, citric acid, and phosphoric acid; and at least one acid chosen from ascorbic acid and bisulfite; to result in the aqueous brine having a pH ranging from 1.5 to 4.5 or other desired pH disclosed herein, thereafter heating the aqueous brine to a temperature above 165° F. or other desired temperature disclosed herein, and thereafter maintaining the aqueous brine at a temperature above 165° F. for at least 15 minutes (or other desired temperature and time disclosed herein). In some embodiments, the aqueous brine is heated to have a temperature elevated from room temperature (70° F.) to the temperature above 165° F. or 175° F. or 180° F. 188° F. or 198° F., or the temperature ranges from 188 to 211° F. As noted above, the period of time ranges from 15 minutes to 360 minutes or from 45 minutes to 200 minutes.

And as noted above, in some embodiments, the method further comprises inverting the first compartment of the first container while maintaining the aqueous brine at a temperature above 165° F. for at least 15 minutes (or other described temperature or time).

In some embodiments, the onions are dehydrated, fresh, or frozen.

In some embodiments, the method further comprises transferring, from the first compartment of the first container to a second compartment of a second container, the onions in an aqueous brine comprising one or more acids chosen from lactic acid, citric acid, and phosphoric acid; and at least one acid chosen from ascorbic acid and bisulfite, and water, and wherein the aqueous brine has a pH ranging from 1.5 to 4.5. In some embodiments, the method further comprises thereafter sealing the second container.

Embodiments herein described make it possible to minimizes the heating, which make it possible to lessen the browning of onions that accompanies heating.

### EXAMPLE 1

### Hot Fill

In the example below, the embodiment refers to chopped onions. But in any embodiment herein, the chopped onions may be accompanied by other vegetables and/or spices.

Dehydrated chopped onions are added to a volumetric filler to a desired amount, e.g., 14 oz, 28 oz, 60 oz. or any desired amount.

The dehydrated onions are added to an open compartment of a container. Aqueous brine is added to a desired level to the open compartment.

The aqueous brine comprises lactic acid, citric acid, at least one acid chosen from ascorbic acid and bisulfite, and water. In some embodiments, the aqueous brine consists of lactic acid, citric acid, at least one acid chosen from ascorbic acid and bisulfite, and water.

The aqueous brine is made by mixing, e.g., in a batch tank, the two or three or four or five acids—lactic acid, citric acid, and at least one acid chosen from ascorbic acid and bisulfite—or conjugate base thereof, or sodium bisulfite, and water to have a desired pH between 1.5 and 3.5 or 1.5 and 4.5.

The aqueous brine is transferred in a feeder feed tank for heating to have a temperature elevated of 188° F. The heated aqueous brine is added to a desired level to the open compartment of the container after the dehydrated onions are added to an opening in a container.

The compartment of the container is sealed and thereafter the sealed container is mixed. The mixing makes it possible to minimize clumping of chopped onions and to minimize forming dry spots in the rehydrated chopped onions. The mixing also makes it possible for the chopped onions to rapidly become rehydrated and acidified.

After mixing, the sealed container is inverted.

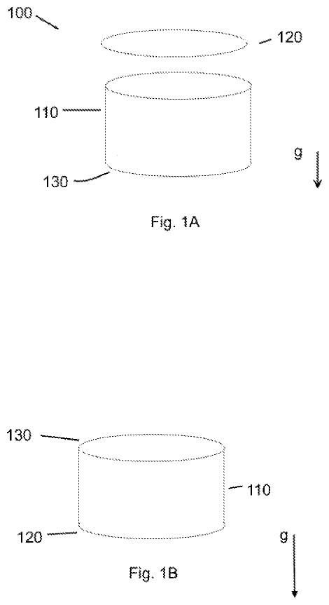

FIG. 1A shows an embodiment of a container 100, which includes an open compartment 110 and a cap 120. Upon adding the dehydrated chopped onions to the open compartment 110, gravity (g) pulls the chopped onions towards the container bottom 130. Upon adding the heated aqueous brine, gravity (g) facilitates settling of the chopped onions towards the container bottom 130.

The container 100 is capped by adding cap 120 to open compartment 110 in order to seal the container. Thereafter the container is mixed.

After mixing, the container is inverted such that gravity (g) facilitates settling of the chopped onions towards the sealed container's cap 120. Inverting makes it possible for the chopped onions to more fully rehydrate and impedes separation of the rehydrated chopped onion into a visible layer.

FIG. 1B shows an embodiment of an inverted sealed container.

The inverted container is held in an environment for a period of time sufficient to sterilize the chopped onions and optional contents by maintaining the temperature of the aqueous brine above 175° F. for 123 minutes.

After a sufficient period of time passes, the container is cooled by removing it from the environment and storing the food product before use.

The dehydrated chopped onion is filled into a container, then topped with hot acid brine. After filling to a desired level, the container is then capped and mixed to minimize clumping or dry spots, and all ingredients in the container are capable of achieving a rapid rehydration and acidification. After sufficiently mixing, the container is then inverted and kept inverted throughout the heating and cooling steps. During heating, the container and its ingredients are held for a time and a temperature sufficient to achieve commercial sterility.

It has been discovered that if the product is kept upright (non-inverted), the container's contents, which include onion, will not fully rehydrate in the container and separation of the onion will be visible later after the processed and capped container is thereafter opened. It has been unexpectedly discovered that inversion of the container during heating and cooling makes an improvement possible. After cooling, the product is reinverted or re-invertible before labelling and final packaging of the container containing the rehydrated onions.

The brine is made of an acid blend sufficient to maintain the quality and safety of the chopped onions on a shelf at ambient temperatures for up to twelve months.

### EXAMPLE 2

In the example below, the embodiment refers to peeled onions. But in any embodiment herein, the peeled onions may be accompanied by other vegetables and/or spices.

Peeled onions are added to a volumetric filler to a desired amount, e.g., 14 oz, 28 oz, 60 oz. or any desired amount.

The peeled onions are added to an open compartment of a container. Aqueous brine consisting of water and sodium bisulfite is added to a desired level to the open compartment.

An aqueous acid solution of three acids—lactic acid, citric acid, and ascorbic acid—and water is made by mixing the conjugate bases of the three acids in water.

The aqueous acid solution is added to the aqueous brine consisting of water and sodium bisulfite. The resultant aqueous brine has a pH of 1.7.

The compartment is sealed and the contents are mixed. The container is invented as described in Example 1. The inverted container is heated so that the contents of the sealed compartment are above 173° F. for 160 minutes.

Afterwards, the container is cooled and storing the food product before use.

In some embodiments, the method further comprises transferring, from the first compartment of the first container to a second compartment of a second container, the onions in an aqueous brine comprising lactic acid, citric acid, at least one acid chosen from ascorbic acid and sodium bisulfite, and water, and wherein the aqueous brine has a pH ranging from 1.5 to 4.5. In some embodiments, the method further comprises thereafter sealing the second container.

### EXAMPLE 3

### Cold Fill Process

An aqueous acid solution of three acids—lactic acid, citric acid, and ascorbic acid—and water is made by mixing the conjugate bases of the three acids in water.

The aqueous acid solution is added to a precursor to the aqueous brine consisting of water and sodium chloride. The resultant aqueous brine has a pH of 1.7.

Peeled onions are added to the aqueous acid solution in which there is 75% onion and 25% brine. The resultant pH of the mixture has a pH ranging from 1.5-4.5.

The mixture of onion and brine is then heated to 173° F. for 160 minutes then cooled to below 120° F. and transferred to a filler.

A sanitized container is then filled with the cooled onion mixture and sealed by a sanitized cap.

The product is then stored before use.

### EXAMPLE 4

### Hot Fill

In Example 1, the lactic and citric acids are replaced with phosphoric acid. The quality and safety of the chopped onions are maintainable on the shelf at ambient temperature for a period of time.

### EXAMPLE 5

In Example 5, the lactic acid is replaced with phosphoric acid in the form of sodium phosphate. The brine pH is 1.6.

### EXAMPLE 6

### Cold Fill Process

In Example 3, the citric acid is replaced with hexametaphosphate. The brine pH is 1.8. The product is storable before use.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An onion food product, comprising onions in an aqueous brine which comprises one or more acids chosen from lactic acid, citric acid, and phosphoric acid; and at least one acid chosen from ascorbic acid and bisulfate, and water, and wherein the aqueous brine has a pH ranging from 1.5 to 4.5.

2. The onion food product of claim 1, wherein the onions have a form chosen from chopped, diced, minced, and sliced onions.

3. The onion food product of claim 1, wherein the onions have a form chosen from whole and peeled onions.

4. The onion food product of claim 1, further comprising at least one spice, wherein onion is the major vegetable ingredient by weight of any vegetables and spices.

5. The onion food product of claim 1, further comprising at least one vegetable different than onion, wherein onion is the major vegetable ingredient by weight of any vegetables and spices.

6. The onion food product of claim 1, wherein
the lactic acid is present in an amount ranging from 0.1 to 8.0 wt/wt % relative to the total weight of the lactic acid, citric acid, and ascorbic acid;
the citric acid is present in an amount ranging from 0.01 to 5.0 wt/wt % relative to the total weight of the lactic acid, citric acid, and ascorbic acid; and
the phosphoric acid is present in an amount ranging from 0.01 to 5.0 wt/wt % relative to the total weight of the lactic acid, citric acid, and phosphoric acid; and
at least one acid chosen from
ascorbic acid is present in an amount ranging from 0.01 to 5.0 wt/wt % relative to the total weight of the lactic acid, citric acid, and ascorbic acid; and
bisulfite is present in an amount ranging from 0.01 to 1.25 wt/wt % relative to the total weight of the lactic acid, citric acid, and bisulfite.

7. An onion product, comprising a container comprising a compartment containing the onion food product of claim 1.

8. A method of nourishing, comprising eating the onion food product of claim 1.

9. A method of making an onion food product, comprising, containing, in a first compartment of a first container, onions and an aqueous brine comprising one or more acids chosen from lactic acid, citric acid, and phosphoric acid; and at least one acid chosen from ascorbic acid and bisulfite, and water, and wherein the aqueous brine has a pH ranging from 1.5 to 4.5.

10. The method of claim 9, further comprising, containing, in the first compartment of the first container, onions and an aqueous brine comprising one or more acids chosen from lactic acid, citric acid, and phosphoric acid; and at least one acid chosen from ascorbic acid and bisulfite, and water, wherein the aqueous brine has a pH ranging from 1.5 to 4.5, and wherein the aqueous brine has a temperature above 165° F.

11. The method of claim 10, further comprising, thereafter maintaining the aqueous brine at a temperature above 165° F. for at least 15 minutes.

12. The method of claim 9, further comprising containing, in the first compartment of the first container, onions and water.

13. The method of claim 12, wherein the water is in the form of the aqueous brine.

14. The method of claim 12, further comprising adding sodium chloride to the water to make a precursor to the aqueous brine.

15. The method of claim 12, further comprising thereafter adding, to the water and onions,
one or more acids chosen from lactic acid, citric acid, and phosphoric acid; and at least one acid chosen from ascorbic acid and sodium bisulfate,
to result in the aqueous brine having a pH ranging from 1.5 to 4.5, thereafter heating the aqueous brine to a temperature above 165° F., and thereafter maintaining the aqueous brine at a temperature above 165° F. for at least 15 minutes.

16. The method of claim 9, wherein the onions are dehydrated, fresh, or frozen.

17. The method of any one of claim 9, further comprising transferring, from the first compartment of the first container to a second compartment of a second container, the onions in an aqueous brine comprising lactic acid, citric acid, ascorbic acid, and water, and wherein the aqueous brine has a pH ranging from 1.5 to 4.5.

18. The method of claim 17, further comprising thereafter sealing the second container.
